(19) United States
(12) Patent Application Publication
(10) Pub. No.: US 2025/0075295 A1
(43) Pub. Date: Mar. 6, 2025

(54) HIGH-PERFORMANCE SINTERED NEODYMIUM-IRON-BORON MAGNET AND PREPARATION METHOD THEREFOR

(71) Applicants: YANTAI ZHENGHAI MAGNETIC MATERIAL CO., LTD., Yantai, Shandong (CN); NANTONG ZHENGHAI MAGNET CO., LTD., Nantong, Jiangsu (CN)

(72) Inventors: Zhiqiang LI, Yantai, Shandong (CN); Ting ZHANG, Yantai, Shandong (CN); Nan ZHAO, Yantai, Shandong (CN); Lingwen XUE, Yantai, Shandong (CN)

(21) Appl. No.: 18/580,639

(22) PCT Filed: Jul. 20, 2022
(86) PCT No.: PCT/CN2022/106752

§ 371 Date: Jan. 19, 2024

(30) Foreign Application Priority Data
Jul. 20, 2021 (CN) 202110819841.5

(51) Int. Cl. C22C 28/00; C22C 1/02; H01F 1/057; H01F 41/02

(52) U.S. Cl. CPC C22C 28/00; C22C 1/02; H01F 1/0577; H01F 41/0293; C22C 2202/02

(57) ABSTRACT

A high-performance sintered neodymium-iron-boron magnet and a preparation method therefor are provided. The magnet is prepared by means of diffusion heat treatment, using R¹ₘFeₙBₚM²_{w} as a substrate and the alloy R^{H}ₓM¹_{y}B_{z} as a diffusion source. A detachable material reaction bucket is employed for diffusion. The diffusion source can be reused to reduce the production cost of the sintered neodymium-iron-boron magnet and can be applied to a magnet of a large size, and can in particular ensure mass production of a cost-effective sintered neodymium-iron-boron product with a thickness of 8-30 mm in an orientation direction.

The present application claims priority to the prior application with the patent application No. 202110819841.5, entitled “HIGH-PERFORMANCE SINTERED NEODYMIUM-IRON-BORON MAGNET AND PREPARATION METHOD THEREFOR”, and filed before China National Intellectual Property Administration on Jul. 20, 2021, which is incorporated herein by reference in its entirety.

### TECHNICAL FIELD

The present disclosure belongs to the field of rare-earth permanent magnet materials, and particularly relates to a high-performance sintered neodymium-iron-boron magnet and a preparation method therefor.

### BACKGROUND

As modern permanent magnets with relatively excellent performance, neodymium-iron-boron magnets differ in their performance, with the high-performance sintered neodymium-iron-boron magnet being the most superior in terms of performance. The high-performance sintered neodymium-iron-boron magnet is a sintered neodymium-iron-boron permanent magnet material with the sum of Hcj (intrinsic coercivity, KOe) and (BH)max (maximum magnetic energy product, MGOe) of greater than 60, which is prepared by the procedures of rapid hardening and strip casting, hydrogen decrepitation, jet milling, pressing, sintering, and the like, and by adopting an oxygen-free process and the like. In recent years, it has been an important goal for various neodymium-iron-boron magnet manufacturers to develop a production process for a neodymium-iron-boron magnet with a small decrease in Br, a small increase in cost, and a significant increase in Hcj. At first, the magnetic energy product and coercivity of neodymium-iron-boron magnets were improved through composition optimization, such as the use of expensive heavy rare-earth elements instead of light rare-earth elements, and the like, and then through grain refinement; meanwhile, grain boundary strengthening processes, such as dual-alloy and dual main phase processes, etc., were also used. However, all of the processes described above require the input of a high proportion of heavy rare-earth elements, which leads to a relatively large reduction in Br; moreover, the reserves of the mainly used heavy rare-earth elements Dy and Tb are limited, and costs are high, thereby restricting the development of these processes. In recent years, a new process of diffusing rare-earth elements and rare-earth alloys into the sintered neodymium-iron-boron grain boundary to improve the Hcj performance of neodymium-iron-boron magnets has developed rapidly in the industry. This process is cost-effective and plays an important role in promoting the conservation of rare-earth permanent magnet resources, the upgrading of products, energy conservation and emission reduction, sustainable development, and the like.

For example, the patent application with the publication number CN101707107A discloses a method for manufacturing a rare-earth permanent magnet material with high remanence and high coercivity, which comprises the process steps of preparing a master alloy, crushing, molding, sintering to prepare a sintered magnet, aging treatment, mechanical processing, and surface treatment, and is characterized in that after the process step of sintering to prepare the sintered magnet R1-T-B-M1, the sintered magnet is embedded in a pre-mixed powder consisting of a heavy rare-earth HR2M2 alloy powder and one or more of powdered R3 oxides, R4 fluorides, and R5 fluorides; wherein HR2 is at least one of Dy, Ho, and Tb; M2 is at least one of Al, Cu, Co, Ni, Mn, Ga, In, Sn, Pb, Bi, Zn, and Ag; R3, R4, and R5 are one or more of rare-earth elements including Y and Sc. In the method described above, a certain gap needs to be reserved between magnets during the diffusion treatment; otherwise, there is a risk of adhesion between the contact surfaces of magnets, which affects their appearance. Therefore, magnets need to be arranged at intervals by operators, which reduces the operational efficiency; moreover the production efficiency is also reduced due to the fact that the arrangement at intervals affects the loading capacity.

The patent application with the publication number CN106298219A discloses a method for preparing an R-T-B rare-earth permanent magnet, comprising the following steps: a) preparing an R^{L}ᵤR^{H}ᵥFe_{100-u-v-w-z}B_{w}M_{z} rare-earth alloy for use as a diffusion source, wherein the R^{L} represents at least one of the elements Pr and Nd; R^{H} represents at least one of the elements Dy, Tb, and Ho; M represents at least one of the elements Co, Nb, Cu, Al, Ga, Zr, and Ti; the rare-earth alloy contains a main phase structure of an R—Fe—B tetragonal crystal; u, v, w, and z are weight percentages of substances, and u, v, w, and z satisfy the following relationships: 0≤u≤10, 35≤v≤70, 0.5≤w≤5, and 0≤z≤5; b) crushing the R^{L}ᵤR^{H}ᵥFe_{100-u-v-w-z}B_{w}M_{z} rare-earth alloy to form an alloy powder; c) putting the alloy powder, together with the R-T-B magnet, into a diffusion apparatus and performing heat diffusion at a temperature range of 750-950° C. for a period of 4-72 h; and d) performing an aging treatment. According to the invention, an R—Fe—B alloy is adopted as the diffusion source alloy. However, when the R—Fe—B alloy is used as the diffusion source and the B content of the diffusion source is too high, the melting point of the diffusion source may become relatively high, resulting in a low diffusion rate. That is, the amount of active ingredient that gets into the substrate within the same period of time is small, and once the temperature of diffusion is increased, the main phase grains will be destroyed, thereby weakening the diffusion effect. Therefore, the diffusion efficiency is poor and the desired performance is not achieved.

The patent application with the publication number CN107731437A discloses a method for reducing irreversible losses of a sintered neodymium-iron-boron sheet magnet, wherein the light rare-earth metal Nd or Pr, or a PrNd alloy rapid-hardening sheet, is mixed with a low-quality sintered neodymium-iron-boron sheet magnet at a certain ratio, and then the mixture is put into a diffusion furnace and subjected to a heat treatment at a certain rotational speed and a certain temperature; finally, the magnet obtained after the diffusion is annealed at 460° C.-520° C. for 3-5 h. According to the invention, the light rare-earth metal Nd or Pr, or a PrNd alloy rapid-hardening sheet, is adopted as the diffusion source, and the element Nd or Pr is diffused into the surface layer region of the sintered neodymium-iron-boron sheet magnet block to repair damaged microstructures in the surface region of the sintered neodymium-iron-boron sheet magnet, thereby improving the coercivity of the sintered neodymium-iron-boron sheet magnet. However, because the diffusion source adopted in the process is light rare-earth elements, which have limited diffusion effect, the process is only relatively effective for sheet products, the improvement in its Hcj performance is limited (an increase of only 1-3 KOe), and the Hcj performance-improving effect is not significant for slightly thicker products. The patent application with the publication No. CN105321702A discloses a method for improving the coercivity of a sintered NdFEB magnet, wherein the coercivity of the sintered NdFeB magnet is improved by a grain boundary diffusion method using a grain boundary diffusion alloy material free of heavy rare-earth elements; the diffusion alloy consists of Re_{100-x-y}AlₓM_{y}, wherein Re is one or more of Ce, Pr, and Nd; M is one or more of Mg and Cu; 2≤X≤33; 0≤y≤5. The process comprises the following specific steps: performing smelting under vacuum to obtain the diffusion alloy, making the diffusion alloy into a powder or rapidly quenching the diffusion alloy into a thin strip, coating the surface of a sintered neodymium-iron-boron magnet with the diffusion alloy, then performing diffusion in a vacuum furnace at 600-1000° C. for 1-10 hours, and performing tempering at 500° C. for 1-5 hours. In addition to the drawbacks of the patent document CN107731437A discussed above, this method also suffers from the following drawbacks: as the diffusion process involves coating the surface of the magnet with the diffusion source, the diffusion source powder or debris can easily stick to the surface of the magnet; moreover, the magnet may have varying degrees of pit defects on the lower surface due to gravity, which affect the size and/or appearance of the product.

The patent application with the publication No. CN103003899A discloses a treating apparatus comprising a diffusion processing part, a separation part, and a heat treatment part, wherein the diffusion processing part is used for heating a Re—Fe—B-based sintered magnet and a diffusion source of a metal or an alloy of a metal RH containing a heavy rare-earth element while rotating; the separation part selectively separates the RH diffusion source from the sintered magnet and the RH diffusion source received by the diffusion processing part; the heat treatment part is used for performing a heat treatment on the Re—Fe—B sintered magnet with the diffused heavy rare-earth element after the RH diffusion source is removed. Temperature lows are easily generated at the linking parts of different chambers in the apparatus, and it is difficult to maintain a uniform temperature zone in the furnace; in addition, since the treatments in the diffusion area and the heat treatment area take more time while the treatment in the separation part takes less time, this continuous treatment furnace cannot better improve efficiency, for example, when the diffusion area has materials and the separation part and the heat treatment part have no material are waiting for materials. Thus, the arrangement of the separate diffusion part, the separate separation part, and the separate heat treatment part does not give the apparatus a significant advantage.

Therefore, there have been urgent technical problems with diffusion processes for sintered neodymium-iron-boron magnets that need to be addressed. These problems include the fusion and adhesion problems between the diffusion source and the substrate, insufficient improvement in Hcj, difficulty in improving diffusion efficiency, the inability to reuse the diffusion source leading to higher costs, and the inapplicability of the diffusion source to larger-sized neodymium-iron-boron magnet products.

### SUMMARY

In order to ease the technical problems described above, the present disclosure provides an R^{H}ₓM¹_{y}B_{z} alloy, wherein the R^{H} is selected from one or two of the elements Dy and Tb; M¹ is selected from one, two, or three of the elements Ti, Zr, and Al; the B represents the element boron; x, y, and z represent the weight percentages of the elements, and x, y, and z satisfy the following relationships: 75%≤x≤90%, 0.1%≤z≤0.5%, and y=1−x−z.

According to an embodiment of the present disclosure, in the R^{H}ₓM¹_{y}B_{z} alloy, 80%≤x≤85%, 0.15%≤z≤0.3%, y=1−x−z; illustratively, x=80%, 81%, 82%, 83%, 84%, or 85%; z=0.1%, 0.15%, 0.2%, 0.25%, or 0.3%.

According to an exemplary embodiment of the present disclosure, in the R^{H}ₓM¹_{y} B_{z} alloy, M¹ is preferably any two of the elements Ti, Zr, and Al, and the mass ratio of the two elements is 1:1 to 2:1, illustratively 1:1, 1.5:1, 1:2, or 2:1.

According to an exemplary embodiment of the present disclosure, in the R^{H}ₓM¹_{y}B_{z} alloy, R^{H} is Dy; M¹ is two of Ti and Al; x=85%; z=0.4%; y=14.6%. For example, the R^{H}ₓM¹_{y}B_{z} alloy is Dy_{85%}Ti_{9.73%}Al_{4.87%}B_{0.4%}.

According to an exemplary embodiment of the present disclosure, in the R^{H}ₓM¹_{y} B_{z} alloy, R^{H} is Tb; M¹ is two of Ti and Zr; x=80%; z=0.3%; y=19.7%. For example, the R^{H}ₓM¹_{y}B_{z} alloy is Tb_{80%}Ti_{11.82%} Zr_{7.88%}B_{0.3%}.

According to an embodiment of the present disclosure, the R^{H}ₓM¹_{y}B_{z} alloy may be in the form of a sheet, for example, with an average thickness of ≤10 mm, preferably ≤5 mm, and illustratively 1 mm, 1.8 mm, 2 mm, 3 mm, 4 mm, or 5 mm.

The present disclosure further provides a preparation method for the R^{H}ₓM¹_{y}B_{z} alloy described above, wherein the preparation method comprises: subjecting starting materials comprising the element R^{H}, the element M¹, and the element B to smelting and rapid hardening to prepare the R^{H}ₓM¹_{y}B_{z} alloy.

According to an embodiment of the present disclosure, the element R^{H}, the element M¹, and the element B are as defined above.

According to an embodiment of the present disclosure, the amount of the element R^{H}, the element M¹, and the element B is weighed out according to a weight ratio of R^{H}:M¹:B=x:y:z, wherein x, y, and z are as defined above.

According to an embodiment of the present disclosure, the smelting is performed in an inert atmosphere; for example, the inert atmosphere may be provided by argon and/or helium, preferably by argon.

According to an embodiment of the present disclosure, the smelting is performed at a temperature of 1350° C. to 1550° C., illustratively 1350° C., 1450° C., 1480° C., or 1500° C.; further, the smelting is performed with a temperature holding time of 0-30 min, illustratively 5 min, 10 min, 20 min, or 30 min.

According to an embodiment of the present disclosure, the smelting is performed until the starting materials are melted down into an alloy liquid.

According to an embodiment of the present disclosure, the preparation method further comprises cooling the alloy liquid obtained by the smelting to a casting temperature.

Preferably, the cooling is performed at a rate of 3-9° C./min, illustratively 3° C./min, 4° C./min, 6° C./min, 8° C./min, or 9° C./min.

Preferably, the casting temperature is 1330 to 1530° C., illustratively 1340° C., 1400° C., 1430° C., or 1450° C.

According to an embodiment of the present disclosure, the preparation method comprises: performing strip casting of the alloy liquid that has been cooled to the casting temperature to obtain an R^{H}ₓM¹_{y}B_{z} rapid-hardening alloy sheet.

According to an embodiment of the present disclosure, the average thickness of the R^{H}ₓM¹_{y}B_{z} rapid-hardening alloy sheet is ≤10 mm, preferably ≤5 mm, and illustratively 1 mm, 2 mm, 3 mm, 4 mm, or 5 mm.

According to an exemplary embodiment of the present disclosure, the preparation method comprises: completely smelting starting materials containing the element R^{H}, the element M¹, and the element B into an alloy liquid in an inert atmosphere, cooling the alloy liquid to a casting temperature, and performing strip casting to obtain an R^{H}ₓM¹_{y}B_{z} rapid-hardening alloy sheet with an average thickness of ≤10 mm.

The present disclosure further provides use of the R^{H}ₓM¹_{y}B_{z} alloy described above in the preparation of a sintered neodymium-iron-boron material, preferably a high-performance sintered neodymium-iron-boron material. The high-performance sintered neodymium-iron-boron material means a sintered neodymium-iron-boron permanent magnet material with the sum of Hcj (intrinsic coercivity, KOe) and (BH)max (maximum magnetic energy product, MGOe) of greater than 60. Preferably, the R^{H}ₓM¹_{y}B_{z} alloy described above is used as a diffusion source in the preparation of a sintered neodymium-iron-boron material.

The present disclosure further provides a sintered neodymium-iron-boron magnet, which is prepared by diffusion heat treatment using R¹ₘFeₙBₚM²_{w} as a substrate and an R^{H}ₓM¹_{y}B_{z} alloy as a diffusion source.

According to an embodiment of the present disclosure, the R^{H}ₓM¹_{y}B_{z} alloy is as defined above.

According to an embodiment of the present disclosure, in the R¹ₘFeₙBₚM²_{w} substrate, the R¹ is selected from one, two or more of the elements Pr, Nd, Dy, Tb, Ho, Gd, Ce, La, and Y; Fe represents the element iron; B represents the element boron; M² is selected from one, two or more of the elements Ti, Zr, Co, V, Nb, Ni, Cu, Zr, Al, and Ga.

Preferably, the R¹ is selected from Nd and Dy, and the M² is selected from Ti, Cu, Ga, and Co.

According to an embodiment of the present disclosure, in the R¹ₘFeₙBₚM²_{w} substrate, m represents the weight percentage content of R¹, and 35%≥m≥27%; illustratively, m=29%, 29.5%, 30%, 31%, or 32%.

According to an embodiment of the present disclosure, in the R¹ₘFeₙBₚM²_{w} substrate, n represents the weight percentage content of Fe, and 70%≥n≥60%; illustratively, n=62%, 64%, 66.5%, 67.5%, or 68.5%.

According to an embodiment of the present disclosure, in the R¹ₘFeₙBₚM²_{w} substrate, p represents the weight percentage content of B, and the content of the element B is 0.8%≤p≤1.5%; illustratively, p=0.8%, 1.0%, or 1.1%.

According to an embodiment of the present disclosure, a preparation method for the R¹ₘFeₙBₚM2_{w} substrate comprises smelting, milling, pressing, sintering, and aging to prepare a magnet, and may further comprise the steps of mechanical processing and surface treatment.

According to an embodiment of the present disclosure, the thickness of the substrate in an orientation direction is no more than 30 mm, e.g., 1-30 mm, and may be divided into 1-8 mm, 8-15 mm, 15-20 mm, or 20-30 mm.

According to an embodiment of the present disclosure, the Hcj (intrinsic coercivity) of the sintered neodymium-iron-boron magnet is no less than 20 kOe; preferably, the Hcj is 21 to 29 kOe, illustratively 23.61 kOe, 24.45 kOe, 25.63 kOe, 26.40 kOe, 27.50 kOe, or 28.89 kOe.

According to an embodiment of the present disclosure, the Br of the sintered neodymium-iron-boron magnet is 13.8 to 14.6 kGs, illustratively, 13.85 kGs, 13.94 kGs, 14.1 kGs, 14.2 kGs, 14.3 kGs, or 14.55 kGs.

According to an embodiment of the present disclosure, the density of the sintered neodymium-iron-boron magnet is 7.50 to 7.60 g/cm³, illustratively, 7.50 g/cm³, 7.56 g/cm³, or 7.60 g/cm³, and preferably 7.56 g/cm³.

The present disclosure further provides a preparation method for the sintered neodymium-iron-boron magnet described above, comprising the following steps:
uniformly mixing the diffusion source R^{H}ₓM¹_{y}B_{z} alloy and the substrate R¹ₘFeₙBₚM²_{w} and performing a diffusion heat treatment to obtain the sintered neodymium-iron-boron magnet.

According to an embodiment of the present disclosure, the mass ratio of the diffusion source R^{H}ₓM¹_{y}B_{z} alloy to the substrate R¹ₘFeₙBₚM²_{w} is (1 to 5): 1, illustratively 1:1, 1.5:1, 2:1, 2.3:1, 3:1, or 5:1.

According to an embodiment of the present disclosure, the diffusion heat treatment is performed using a staged heating and cooling mode. Preferably, a three-staged heating and cooling mode is used.

According to an embodiment of the present disclosure, in the first stage of the three-staged heating and cooling mode, the temperature is raised to 300 to 650° C., illustratively 400° C., 480° C., 550° C., or 650° C., and held for 1-8 h, illustratively 2 h, 4 h, 6 h, or 8 h;
in the second stage, the temperature is raised to 750 to 980° C., illustratively 800° C., 850° C., 930° C., or 980° C., and held for 7 to 50 h, illustratively 10 h, 20 h, 30 h, 40 h, or 50 h;
in the third stage, the temperature is lowered to 700 to 930° C., illustratively 750° C., 800° C., 880° C., or 930° C., and held for 3 to 20 h, illustratively 5 h, 10 h, 15 h, or 20 h.

For example, for the stages, the rate of heating is 3 to 15° C./min, illustratively 6° C./min or 10° C./min, and the rate of cooling is 5 to 30° C./min, illustratively 6° C./min, 10° C./min, or 20° C./min.

According to an embodiment of the present disclosure, the diffusion heat treatment further comprises an aging treatment. Preferably, the aging treatment is performed at a temperature of 400 to 680° C., illustratively 400° C., 500° C., 520° C., 600° C., or 680° C.; and the aging treatment is performed with a temperature holding time of 2 to 10 h, illustratively 2 h, 4 h, 6 h, 8 h, or 10 h.

According to an embodiment of the present disclosure, the diffusion heat treatment is performed in a detachably mounted diffusion apparatus. The detachably mounted material reaction bucket can be conveniently replaced, and when a bucket of material has been processed, it can be processed in the next furnace immediately, which facilitates the continuous production of sintered neodymium-iron-boron magnets.

### Advantageous Effects

(1) According to the present disclosure, the R^{H}ₓM¹_{y}B_{z} alloy is used as a diffusion source and a detachable reaction bucket is adopted for diffusion; in this way, cost-effective rare-earth permanent magnets are efficiently produced; further, the fusion and adhesion problems between the diffusion source and the substrate in the diffusion process are solved, the Hcj of the sintered neodymium-iron-boron magnet is improved, and the problem with improving efficiency in the diffusion process is solved. Furthermore, the diffusion source of the present disclosure can be reused to reduce the production cost of the high-performance sintered neodymium-iron-boron magnet and can be applied to larger-sized magnets; it can in particular ensure mass production of cost-effective sintered neodymium-iron-boron products with a thickness of 8-30 mm in the orientation direction.

(2) In the present disclosure, the diffusion source R^{H}ₓM¹_{y}B_{z} alloy in which R^{H} is one of or a combination of Dy and Tb is used for diffusion, and when the content of the element B is controlled to be 0.1%≤z≤0.5%, the melting point of the R^{H}ₓM¹_{y}B_{z} alloy can be improved to some extent, while ensuring that Dy and Tb can be efficiently diffused into the interior of a magnet in the diffusion process; thus, the waste caused by the sublimation of Dy, Tb and the like due to high temperature can be avoided; M¹ is selected from one or more of the elements Ti, Zr, and Al, and a properly optimized ratio of the ingredients described above can effectively improve the temperature stability of the diffusion source while ensuring the diffusion effect of the heavy rare-earth elements, thereby significantly improving the Hcj and the magnetic energy product of the sintered neodymium-iron-boron magnet to prepare high-performance sintered neodymium-iron-boron material magnets.

(3) According to the present disclosure, the material reaction bucket inside the diffusion apparatus is detachably mounted and thus can be alternately used, thereby facilitating continuous feeding and discharging and greatly improving production efficiency; meanwhile, as the diffusion source and the substrate are in contact and relative movement all the time in the diffusion process, the adhesion between substrates and the adhesion between the diffusion source and the substrate can be avoided, and effective diffusion can be achieved to improve the performance of the sintered neodymium-iron-boron material magnet.

(4) According to the present disclosure, a three-staged heating and cooling diffusion heat treatment mode is adopted, wherein the first temperature holding stage is intended to remove residual moisture and organic matter from the diffusion source and the surface and interior of the substrate; and when the temperature is lower than 300° C., the temperature holding time is longer and the energy consumption is high; when the temperature is higher than 650° C., the grain boundaries on the surface of the magnet tends to be in a molten state, and diffusion may preferentially occur in certain individual parts, resulting in uneven diffusion and relatively large fluctuations in performance in the process of reheating; the second heat holding stage is intended to ensure that the diffusion source fully reacts with the substrate, so that heavy rare-earth elements in the diffusion source can be effectively concentrated in a narrow range near the grain boundaries, in order to improve the Hcj of the magnet and reduce the loss of remanence; when the temperature is lower than 750° C., the diffusion rate of heavy rare-earth elements decreases, which is not conducive to improving the Hcj performance of the magnet, and the utilization rate of heavy rare-earth elements is also relatively low; when the temperature is higher than 980° C., the heavy rare-earth elements still continue to diffuse into the main phase Nd₂Fe₁₄B after entering the grain boundary phase, thereby destroying the crystalline structure and causing reductions in both Br and Hcj of the magnet. Therefore, according to the present disclosure, the temperature for the second stage of heat treatment is controlled within the range of 750 to 980° C. to prepare a high-performance sintered neodymium-iron-boron material magnet; the temperature for the third stage of cooling is set to be 20-50° C. lower than that for the second stage, with the aim of generating a small drop in temperature that allows the diffusion source to flow better in order to enhance diffusion effects.

### DETAILED DESCRIPTION

The technical solutions of the present disclosure will be described in further detail with reference to the following specific examples. It should be understood that the following examples are merely exemplary illustrations and explanations of the present disclosure, and should not be construed as limiting the protection scope of the present disclosure. All techniques implemented based on the content of the present disclosure described above are included within the protection scope of the present disclosure.

Unless otherwise stated, the starting materials and reagents used in the following examples are all commercially available products, or can be prepared by using known methods.

### Example 1

(1) An R¹ₘFeₙBₚM²_{w} substrate was prepared by a smelting method: Starting materials were smelted in an argon atmosphere; the alloy formula consisted of 29.5% Nd, 0.5% Dy, 1.0% B, 0.2% Ti, 0.2% Cu, 0.1% Ga, 1% Co, and the balance of Fe; the starting materials prepared according to the formula proportions were added into a smelting furnace; after the alloy was molten, the temperature was raised to 1480° C. and held for 5 min, and then lowered to 1400° C. for casting; rapid-hardening sheets with an average thickness of 0.28 mm were obtained through a strip casting process.

(2) Milling: A powder with an average granularity of 3.0 μm was obtained by hydrogen decrepitation+jet milling.

(3) Pressing: The powder was pressed into a compact under a magnetic field and subjected to isostatic pressing to form a compact of about 4.6 g/cm³.

(4) Sintering and molding: The compact was first heated at 350° C. for 3 h, then heated at 850° C. for 1 h for degassing, then heated at a high temperature of 1060° C. for 120 min for sintering, and finally aged at 520° C. for 300 min to form a sintered neodymium-iron-boron substrate.

(5) The substrate prepared in step (4) was processed to obtain a product with the dimensions of 40-20-5 mm (i.e., the thickness was 5 mm), and the product was subject to surface chemical pretreatments including degreasing, washing, and acid washing to make the surface of the substrate free of oxide skin and to prevent the diffusion of the diffusion source from being inhibited.

(6) Starting materials were smelted in an argon atmosphere to give the diffusion source R^{H}ₓM¹_{y}B_{z} alloy, which consists of 85% Tb, 0.4% B, and the balance of Ti+Al (mass ratio of 2:1); after the alloy was melted down, the alloy liquid was heated at 1500° C. for 10 min and then cooled to 1430° C. for casting, and rapid-hardening thick sheets with an average thickness of 1.8 mm were obtained through a strip casting process.

(7) Diffusion treatment: The R¹ₘFeₙBₚM²_{w} substrate that had undergone the surface pretreatments in step (5) and the R^{H}ₓM¹_{y} B_{z} diffusion source alloy prepared in step (6) were uniformly distributed in an internal reaction bucket (the mass ratio of the substrate to the diffusion source alloy was 1:2.3), and then the reaction bucket was put into a diffusion furnace. The pressure was reduced to no more than 100 Pa using a pump. The temperature for the first stage of the diffusion was 400° C., and the temperature was held for 4 h. The temperature for the second stage was 930° C., and the temperature was held for 20 h. The temperature for the third stage was 880° C., and the temperature was held for 10 h. For the stages, the rate of heating was 6° C./min, and the rate of cooling was 10° C./min. Aging was performed at 520° C. for 4 h to obtain a sintered neodymium-iron-boron magnet.

### Comparative Example 1

Comparative Example 1 differs from Example 1 in that the R^{H}ₓM¹_{y}B_{z} diffusion source consists of the following elements: 85% Tb, no B, and the balance of Ti+Al (mass ratio of 2:1).

### Comparative Example 2

Comparative Example 2 differs from Example 1 in that the R^{H}ₓM¹_{y}B_{z} diffusion source consists of the following elements: 85% Tb, 1% B, and the balance of Ti+Al (mass ratio of 2:1).

The influence of the B content in the diffusion material on the appearance and magnetic properties of the post-diffusion magnet was examined by adjusting the B content in the diffusion material in Comparative Examples 1 and 2 (the appearance was examined as follows: after a certain amount of material was discharged from the furnace, 100% of the material was examined; if no adhesion was found between two or more magnet pieces after the end of the diffusion for the furnace material, the appearance adhesion ratio was regarded as 0%, and if adhesion was found between two or more pieces and they could not be separated, such pieces were regarded as adhesion pieces and the adhesion ratio=(number of adhered pieces/total number of discharged pieces)×100%). The results are shown in Table 1 below.

TABLE 1
Comparison of the appearances and magnetic properties of the magnets
obtained in Example 1 and Comparative Examples 1 and 2

| | | | | Appearance and magnetic | | |
|---|---|---|---|---|---|---|
| | | Thickness | | properties after diffusion | | |
| | Ratios of elements in | of | | Appearance | | |
| | diffusion material | substrate | Diffusion | adhesion | Br | Hcj |
| Item | (mass ratios) | product | process | ratio | (kGs) | (kOe) |
| Example 1 | 85% Tb, 0.4% B, | 5 mm | Three- | 0.005% | 14.20 | 26.1 |
| | 9.73% Ti, 4.87% Al | | staged | | | |
| Comparative | 85% Tb, 0% B, 10% Ti, | 5 mm | Three- | 2.01% | 14.18 | 26.2 |
| Example 1 | 5% Al | | staged | | | |
| Comparative | 85% Tb, 1% B, 9.33% Ti, | 5 mm | Three- | 0.006% | 14.26 | 25 |
| Example 2 | 4.67% Al | | staged | | | |

As can be seen from the results in Table 1, the addition of a proper amount of B can improve the melting point of the R^{H}ₓM¹_{y}B_{z} alloy to some extent, so as to avoid adhesion caused by the molten surface of the R^{H}ₓM¹_{y}B_{z} diffusion source alloy, and reduce the appearance adhesion ratio between magnets, thereby improving the appearance of the magnets discharged from the furnace and effectively enhancing the Hcj of the magnets; however, if the B content is too high, the diffusion channel may be affected, and thus the improvements to the Hcj of the magnets after diffusion may be affected.

### Example 2

(1) An R¹ₘFeₙBₚM²_{w} substrate was prepared by a smelting method: Starting materials were smelted in an argon atmosphere; the alloy consisted of 29.5% Nd, 0.5% Dy, 1.0% B, 0.2% Ti, 0.2% Cu, 0.1% Ga, 1% Co, and the balance of Fe; after the alloy was molten, the temperature was raised to 1480° C. and held for 5 min, and then lowered to 1400° C. for casting; rapid-hardening sheets with an average thickness of 0.28 mm were obtained through a strip casting process.

(2) Milling: A powder with an average granularity of 3.0 μm was obtained by hydrogen decrepitation+jet milling.

(3) Pressing: The powder was pressed into a compact under a magnetic field and subjected to isostatic pressing to form a compact of about 4.6 g/cm³.

(4) Sintering and molding: The compact was first heated at 350° C. for 3 h, then heated at 850° C. for 1 h for degassing, then heated at a high temperature of 1060° C. for 120 min for sintering, and finally aged at 520° C. for 300 min to form a sintered neodymium-iron-boron substrate.

(5) The substrate prepared in step (4) was processed to obtain a product with the dimensions of 40-20-10 mm (i.e., the thickness was 10 mm), and the product was subject to surface chemical pretreatments including degreasing, washing, and acid washing to make the surface of the substrate free of oxide skin and to prevent the diffusion of the diffusion source from being inhibited.

(6) Starting materials were smelted in an argon atmosphere to give the diffusion source R^{H}ₓM¹_{y}B_{z} alloy, which consists of 80% Tb, 0.3% B, and the balance of Ti+Zr (mass ratio of 1.5:1); after the alloy was melted down, the alloy liquid was heated at 1500° C. for 10 min and then cooled to 1430° C. for casting, and rapid-hardening thick sheets with an average thickness of 2.0 mm were obtained through a strip casting process.

(7) Diffusion treatment: The R¹ₘFeₙBₚM²_{w} substrate that had undergone the surface pretreatments in step (5) and the R^{H}ₓM¹_{y}B_{z} diffusion source alloy prepared in step (6) were uniformly distributed in an internal reaction bucket (the substrate and the diffusion material were loaded into the furnace at a mass ratio of 1:2). The pressure was reduced to no more than 100 Pa using a pump. The temperature for the first stage of the diffusion was 400° C., and the temperature was held for 4 h. The temperature for the second stage was 930° C., and the temperature was held for 30 h. The temperature for the third stage was 880° C., and the temperature was held for 10 h. For the stages, the rate of heating was 6° C./min, and the rate of cooling was 10° C./min. Aging was performed at 500° C. for 6 h.

### Comparative Example 3

Comparative Example 3 differs from Example 2 only in that the R^{H}ₓM¹_{y}B_{z} diffusion source consists of the following elements: 70% Tb, 0.3% B, and the balance of Ti+Zr (mass ratio of 1.5:1).

### Comparative Example 4

Comparative Example 4 differs from Example 2 in that a two-staged treatment was adopted for the diffusion in step (7). That is, the temperature for the first stage of the diffusion was 400° C., and the temperature was held for 4 h; the temperature for the second stage was 930° C., and the temperature was held for 30 h; for both stages, the rate of heating was 6° C./min, and the rate of cooling was 10° C./min; aging was performed at 500° C. for 6 h.

### Example 3

This example differs from Example 2 in that:

(1) the R¹ₘFeₙBₚM²_{w} substrate was processed to obtain a product with the dimensions of 40-20-15 mm (i.e., the thickness was 15 mm);

(2) the temperature for the second stage of the diffusion was 930° C., and the temperature was held for 40 h.

The appearances and magnetic properties of the magnets obtained in Examples 2-3 and Comparative Examples 3-4 were tested, and the results are shown in Table 2 below.

TABLE 2
Comparison of the appearances and magnetic properties of the
magnets obtained in Examples 2-3 and Comparative Examples 3-4

| | Ratios of elements in | Thickness | | Performance after diffusion | |
|---|---|---|---|---|---|
| | diffusion material | of substrate | Diffusion | Br | Hcj |
| Item | (mass ratios) | product | process | (kGs) | (kOe) |
| Example 2 | 80% Tb, 0.3% B, 11.82% | 10 mm | Three- | 14.25 | 25.9 |
| | Ti, 7.88% Zr | | staged | | |
| Comparative | 70% Tb, 0.3% B, 17.82% | 10 mm | Three- | 14.30 | 25.2 |
| Example 3 | Ti, 11.88% Zr | | staged | | |
| Example 3 | 80% Tb, 0.3% B, 11.82% | 15 mm | Three- | 14.27 | 25.7 |
| | Ti, 7.88% Zr | | staged | | |
| Comparative | 80% Tb, 0.3% B, 11.82% | 10 mm | Two- | 14.29 | 25.0 |
| Example 4 | Ti, 7.88% Zr | | staged | | |

As can be seen from Table 2 above, the proportion of Tb was decreased in Comparative Example 3 compared to Example 2, and the Hcj of the magnet prepared after the diffusion was reduced; the diffusion process was adjusted in Comparative Example 4 from a three-staged heating and cooling diffusion mode to a two-staged heating and cooling diffusion mode, and the Hcj of the magnet thus prepared was reduced. The results of Example 3 show that when the thickness of the R¹ₘFeₙBₚM²_{w} substrate is increased, the Hcj performance of the post-diffusion magnet can also be improved by adjusting the duration of the three-staged heating and cooling diffusion treatment.

The above examples illustrate the embodiments of the present disclosure. However, the present disclosure is not limited to the embodiments described above. Any modification, equivalent replacement, improvement, and the like made without departing from the spirit and principle of the present disclosure shall fall within the protection scope of the present disclosure.

1. An R^{H}ₓM¹_{y}B_{z} alloy, wherein the R^{H} is selected from one or two of the elements Dy and Tb; M¹ is selected from one, two, or three of the elements Ti, Zr, and Al; the B represents the element boron; x, y, and z represent the weight percentages of the elements, and x, y, and z satisfy the following relationships: 75%≤x≤90%, 0.1%≤z≤0.5%, and y=1−x−z.

2. The R^{H}ₓM¹_{y}B_{z} alloy according to claim 1, wherein in the R^{H}ₓM¹_{y}B_{z} alloy, 80%≤x≤85%, 0.15%≤z≤0.3%, and y=1−x−z;
preferably, in the R^{H}ₓM¹_{y}B_{z} alloy, M¹ is any two of the elements Ti, Zr, and Al, and the mass ratio of the two elements is 1:1 to 2:1;
preferably, the R^{H}ₓM¹_{y}B_{z} alloy may be in the form of a sheet, for example, with an average thickness of ≤10 mm; preferably, the average thickness is ≤5 mm.

3. A preparation method for the R^{H}ₓM¹_{y}B_{z} alloy according to claim 1, wherein the preparation method comprises: subjecting starting materials comprising the element R^{H}, the element M¹_{y} and the element B to smelting and rapid hardening to prepare the R^{H}ₓM¹_{y}B_{z} alloy;
preferably, the element R^{H}, the element M¹_{y} and the element B are defined as in claim 1;
preferably, the amount of the element R^{H}, the element M¹, and the element B is weighed out according to a weight ratio of R^{H}:M¹:B=x:y:z, wherein x, y, and z are as defined in claim 1.

4. The preparation method according to claim 3, wherein the smelting is performed in an inert atmosphere; preferably, the inert atmosphere is provided by argon;
preferably, the smelting is performed at a temperature of 1350° C. to 1550° C., and the smelting is performed with a holding time of 0-30 min;
preferably, the smelting is performed until the starting materials are melted down into an alloy liquid;
preferably, the preparation method further comprises cooling the alloy liquid obtained by the smelting to a casting temperature;
preferably, the cooling is performed at a rate of 3-9° C./min;
preferably, the casting is performed at a temperature of 1330 to 1530° C.

5. The preparation method according to claim 3, wherein the preparation method comprises: performing strip casting of the alloy liquid that has been cooled to the casting temperature to obtain an R^{H}ₓM¹_{y}B_{z} rapid-hardening alloy sheet;
preferably, the average thickness of the R^{H}ₓM¹_{y}B_{z} rapid-hardening alloy sheet is ≤10 mm;
preferably, the average thickness is ≤5 mm;
preferably, the preparation method comprises: completely smelting starting materials containing the element R^{H}, the element M¹, and the element B into an alloy liquid in an inert atmosphere, cooling the alloy liquid to a casting temperature, and performing strip casting to obtain an R^{H}ₓM¹_{y}B_{z} rapid-hardening alloy sheet with an average thickness of ≤10 mm.

6. Use of the R^{H}ₓM¹_{y}B_{z} alloy according to claim 1 in the preparation of a sintered neodymium-iron-boron material, preferably a high-performance sintered neodymium-iron-boron material, wherein
preferably, the R^{H}ₓM¹_{y}B_{z} alloy according to claim 1 is used as a diffusion source in the preparation of the sintered neodymium-iron-boron material.

7. A sintered neodymium-iron-boron magnet, wherein the magnet is prepared by diffusion heat treatment using R¹ₘFeₙBₚM²_{w} as a substrate and an R^{H}ₓM¹_{y} B_{z} alloy as a diffusion source;
preferably, the R^{H}ₓM¹_{y} B_{z} alloy is as defined in claim 1.

8. The magnet according to claim 7, wherein in the R¹ₘFeₙBₚM²_{w} substrate, the R¹ is selected from one, two or more of the elements Pr, Nd, Dy, Tb, Ho, Gd, Ce, La, and Y; Fe represents the element iron; B represents the element boron; M² is selected from one, two or more of the elements Ti, Zr, Co, V, Nb, Ni, Cu, Zr, Al, and Ga;
preferably, the R¹ is selected from Nd and Dy, and the M² is selected from Ti, Cu, Ga, and Co;
preferably, in the R¹ₘFeₙBₚM²_{w} substrate, m represents the weight percentage content of R¹, and 35%≥m≥27%;
preferably, in the R¹ₘFeₙBₚM²_{w} substrate, n represents the weight percentage content of Fe, and 70%≥n≥60%;
preferably, in the R¹ₘFeₙBₚM²_{w} substrate, p represents the weight percentage content of B, and the content of the element B is 0.8%≤p≤1.5%;
preferably, a preparation method for the R¹ₘFeₙBₚM²_{w} substrate comprises smelting, milling, pressing, sintering, and aging to prepare a magnet, and may further comprise the steps of mechanical processing and surface treatment;
preferably, the thickness of the substrate in an orientation direction is no more than 30 mm; for example, the thickness is 1-30 mm.

9. The magnet according to claim 7, wherein the Hcj (intrinsic coercivity) of the sintered neodymium-iron-boron magnet is no less than 20 kOe; preferably, the Hcj is 21 to 29 kOe;
preferably, the Br of the sintered neodymium-iron-boron magnet has Br is 13.8 to 14.6 kGs;
preferably, the density of the sintered neodymium-iron-boron magnet is 7.50 to 7.60 g/cm³.

10. The preparation method for the magnet according to claim 7, wherein the preparation method comprises the following steps:
uniformly mixing the diffusion source R^{H}ₓM¹_{y}B_{z} alloy and the substrate R¹ₘFeₙBₚM²_{w} and performing a diffusion heat treatment to obtain the sintered neodymium-iron-boron magnet;
preferably, the mass ratio of the diffusion source R^{H}ₓM¹_{y}B_{z} alloy to the substrate R¹ₘFeₙBₚM²_{w} is (1 to 5):1;
preferably, the diffusion heat treatment is performed using a staged heating and cooling mode; preferably, a three-staged heating and cooling mode is used;
preferably, in the first stage of the three-staged heating and cooling mode, the temperature is raised to 300 to 650° C. and held for 1-8 h;
in the second stage, the temperature is raised to 750 to 980° C. and held for 7 to 50 h;
in the third stage, the temperature is lowered to 700 to 930° C. and held for 3 to 20 h;
preferably, for the stages, the rate of heating is 3 to 15° C./min, and the rate of cooling is 5 to 30° C./min;
preferably, the diffusion heat treatment further comprises an aging treatment;
preferably, the aging treatment is performed at a temperature of 400 to 680° C., and the aging treatment is performed with a temperature holding time of 2 to 10 h.
